(19) United States
(12) Patent Application Publication
(10) Pub. No.: US 2018/0148257 A1
(43) Pub. Date: May 31, 2018

(54) DUMPSTER WITH A MOVEABLE FALSE FLOOR

(71) Applicant: NEXT MILLENNIUM DUMPSTERS, LLC, CHARLOTTE, NC (US)

(72) Inventor: TONY GARAGIOLA, Charlotte, NC (US)

(21) Appl. No.: 15/364,782

(22) Filed: Nov. 30, 2016

(51) Int. Cl. B65F 1/12; B65F 1/02; B65F 1/16; B65G 65/23

(52) U.S. Cl. CPC B65F 1/125; B65G 65/23; B65F 1/1646; B65F 1/02

(57) ABSTRACT

A waste dumpster is disclosed that includes a container defined by vertically oriented walls, a fixed floor that closes the bottom of the dumpster and a hinged lid opposite the floor. A moveable floor is above the fixed floor and moves unaided in the walled container depending on the orientation of the dumpster. The moveable floor can be a planar member congruent in size and shape to the fixed floor and is coupled to the fixed floor by a plurality of fixed length restraints that define the movement of the false floor when the container is tilted from a non-upright position towards an inverted position. The movable floor has flexible edges coplanar with the remainder of the movable floor for allowing the movable floor to move more easily when the container is tilted.

### RELATED APPLICATIONS

The present invention is related to Ser. No. 11/789,610 filed Apr. 25, 2007 for “Dumpster with a Movable False Floor and Method of Collecting Trash using the same,” and now U.S. Pat. No. 8,944,276.

### BACKGROUND

The present invention relates to trash collection receptacles, and more particularly to a dumpster that empties quickly without the need of shaking or banging the dumpster using the hydraulic lifting-tilting system.

Dumpsters and other trash receptacles are typically unloaded using large trash collection trucks with hydraulic lifting-tilting systems that lift and tilt the dumpster to an inverted position. In the tilted position the trash is no longer supported by the dumpster's floor, and a portion of the trash is pulled by gravity into the bay of the trash collection truck through the collection port. Even though the dumpster is fully or partially inverted, a residual portion of trash tends to be retained therein, adhered to the sidewalls and rim of the dumpster. Adhesive-like materials, such as proteinaceous mixtures, sugars, starches, and other polymeric materials, typically hold the residual trash. To dislodge the residual trash the truck's hydraulic system is used to violently shake and bang the dumpsters. The violent action is relatively effective at breaking loose the retained trash, however, the shaking and banging is noisy, it bends and knocks paint off the dumpsters, and it applies a tremendous strain on the trash collection truck's hydraulic lifting-tilting system. The strain results in much higher maintenance cost of the hydraulic lift system which is often the largest single maintenance issue on the entire truck because of the multiple pivot points and their respective pins, bushings and related parts. The cost directly attributable to shaking and banging dumpsters is on the order of several thousand dollars per month per truck at current prices. There are an estimated 140,000-160,000 trash collection trucks with hydraulic lifting-tilting systems in the United States, and the annual maintenance cost for the hydraulic lifting-tilting systems alone is several billion dollars.

In many cases, the moving arms on the truck are lubricated at least daily, and the overall cost of this and other maintenance is severe enough to make frequent new truck purchases a viable option to extended maintenance.

As another factor, the noise that is produced during trash collection and generated during the process of violently shaking and banging to dislodge the residual trash limits the collection hours during which the public will accept the disruptive noise, and requires (for example) a municipality to purchase, use, and maintain more trucks for fewer working hours.

### SUMMARY

In one aspect the invention is a waste dumpster that includes a container defined by vertically oriented walls, a fixed floor that closes the bottom of the dumpster and a hinged lid opposite the floor. A moveable floor is above the fixed floor and moves unaided in the walled container depending on the orientation of the dumpster. The moveable floor can be a planar member congruent in size and shape to the fixed floor and coupled to the fixed floor by a plurality of fixed length restraining means that define the movement of the moveable floor when the container is tilted from a non-upright position towards an inverted position. The movable floor has flexible edges coplanar with the remainder of the movable floor for allowing the movable floor to move more easily when the container is tilted.

In another aspect, the waste dumpster is a container defined by vertically oriented walls, a bottom area defined by the walls and a top opening opposite the bottom area of the dumpster. A moveable floor is adjacent the bottom area and moves unaided in the walled container depending on the orientation of the dumpster. The moveable floor includes a planar member congruent in size and shape to the bottom area and is coupled to the vertically oriented walls by a plurality of fixed length restraints that define the movement of the moveable floor when the container is tilted from a non-upright position towards an inverted position. The movable floor has flexible edges coplanar with the remainder of the movable floor for allowing the movable floor to move more easily when the container is tilted.

In another aspect, the invention is a method of collecting trash from a dumpster. In this aspect the invention includes the steps of engaging, using a hydraulic lifting-tilting system, a dumpster that includes a movable floor that is fixed to bottom portions of the dumpster to define a modest range of travel for the movable floor; and in which the moveable floor has flexible edges coplanar with the remainder of the movable floor; raising the dumpster from its storage location to a position substantially above a collection port of a trash collection truck; and tilting the dumpster from an upright orientation towards an inverted orientation so that the moveable floor drops a predetermined length defined by the range of travel from the bottom of the dumpster, to thereby push trash out of the dumpster through a top opening, and so that the movable floor shakes the dumpster when the movable floor reaches its defined range of travel to further dislodge adhered trash.

The foregoing and other objects will become more readily apparent by referring to the following detailed description and the appended drawings.

### BRIEF DESCRIPTION OF THE DRAWINGS

FIG. 1 is a side view of the invented dumpster with a movable false bottom and a trash collection truck, diagrammatically illustrating that when the dumpster is lifted and tilted toward an inverted orientation, the bottom moves downward, therein pushing trash out of the top opening and causing the dumpster to shake.

FIG. 2a is a side view of the invented dumpster having an upright orientation, wherein the viewer can see the restraining means in a collapsed mode and the position of the movable false bottom.

FIG. 2b is a side view of the invented dumpster having an inverted orientation, wherein the viewer can see the restraining means fully extended to a predetermined length and the position of the movable false bottom when the restraining means are fully extended.

FIG. 3 is a perspective elevational view of the inverted dumpster without a covering lid, wherein a side-wall 14 of the dumpster is removed to enable the viewer to see the interior of the dumpster.

FIG. 4 is a perspective elevational view of the inverted dumpster without a covering lid, just prior to movement by the movable false bottom, wherein the planar member forming the movable false bottom of the dumpster is structurally reinforced with a beam.

FIGS. 5 and 6 are cutaway views illustrating the flexible edges of the movable floor in more detail.

### DETAILED DESCRIPTION

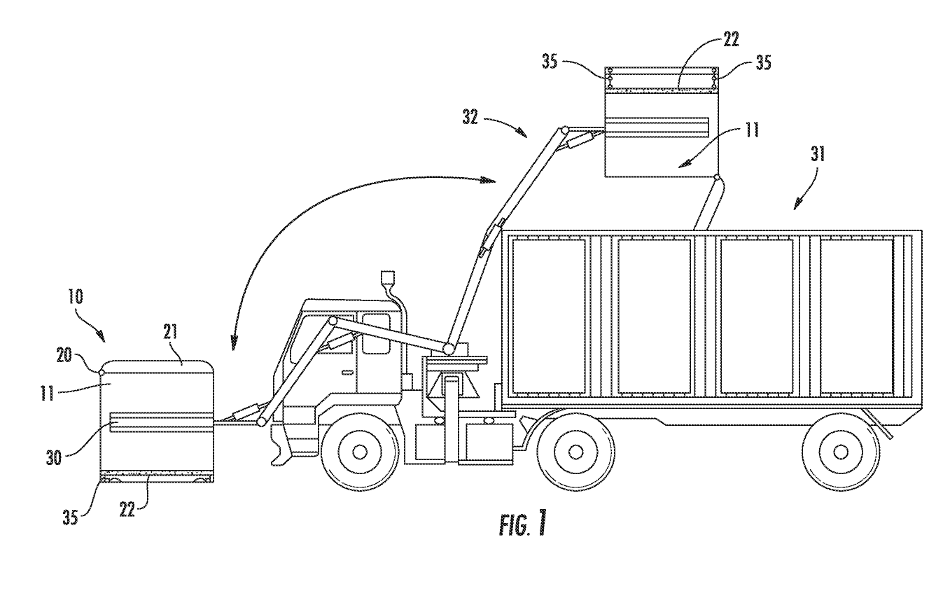

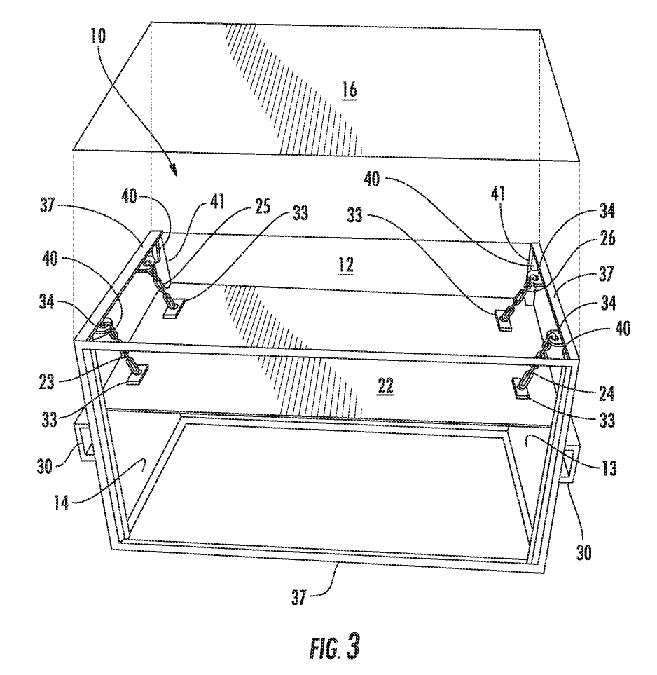

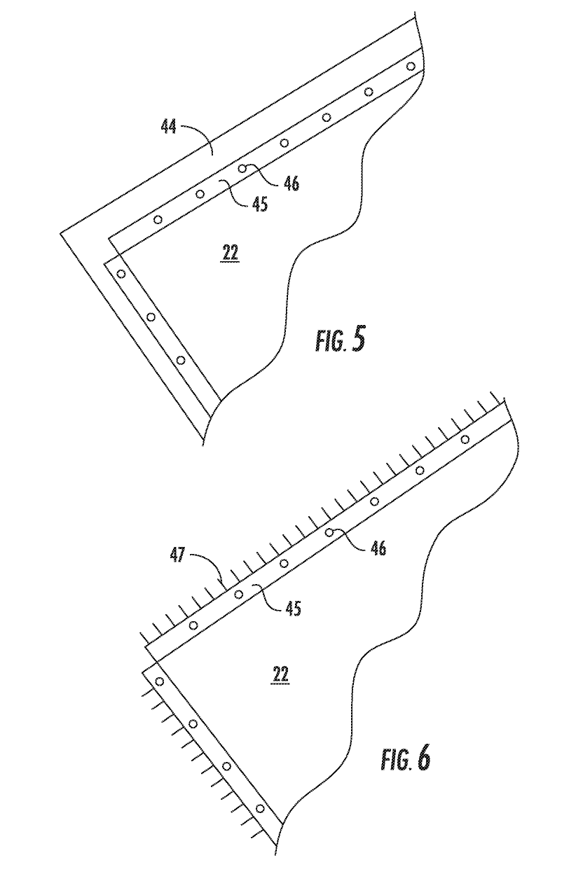

Referring now to the drawings, and particularly to FIGS. 1, 2a, 2b, and 3, the invented dumpster 10 is a container 11 defined by vertically oriented walls 12, 13, 14 and 15. In one embodiment, a fixed floor 16 (FIG. 3) closes the bottom 17 of the container 11. A hinged 20 lid 21 is opposite the fixed floor 16. A movable floor 22 is above the fixed floor 16 and moves unaided in the container 11 depending on the orientation of the dumpster 10. The movable floor 22 includes a planar member congruent in size and shape to the fixed floor 16 and is coupled to the fixed floor 16 by a plurality of fixed length restraints 23, 24, 25, and 26 that define the movement of the movable floor 22 when the container 11 is tilted from a non-upright position towards an inverted position. The movable floor 22 has flexible edges (FIGS. 5 and 6) coplanar with the remainder of the movable floor 22 for allowing the movable floor 22 to move more easily when the container is tilted.

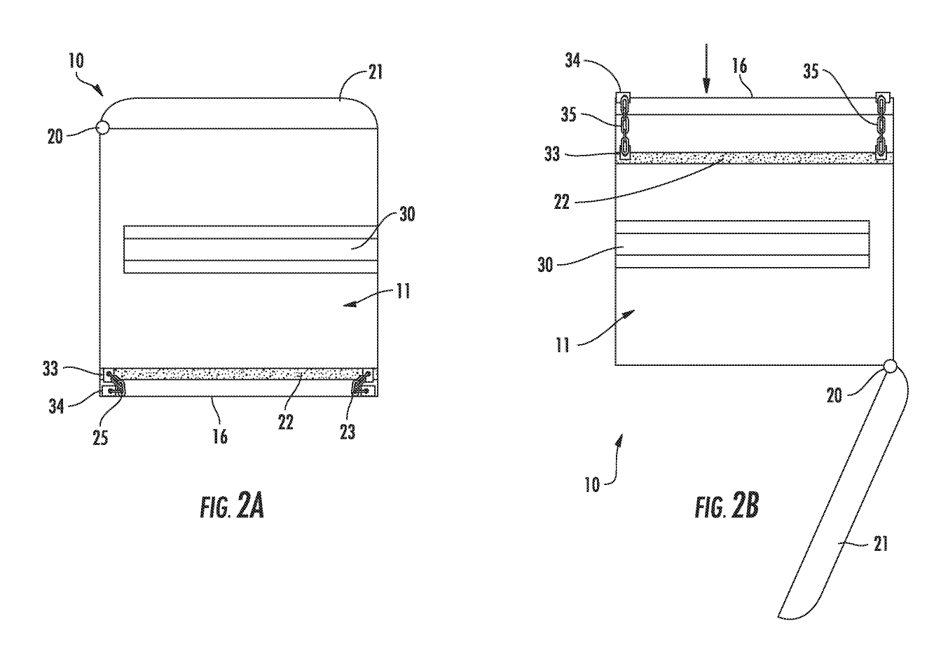

The illustrated dumpster 10 has forklift channels 30 that receive and are engaged by forks on a trash collection truck 31 fitted with a hydraulic lifting-tilting system broadly designated at 32. The dumpster 10 has a moveable false floor 22 comprised of a planar member that substantially forms the cross-sectional area of the floor. Attached or otherwise a part of the planar member are a plurality of upper coupling elements 33, on a lower side of the planar member (moveable false floor 16). A plurality of lower coupling elements 34 are fixedly attached to the dumpster 10 proximate to the bottom 17. There is a restraining means comprised of a plurality of connecting elements illustrated as the chains 35 attached to upper coupling elements 33 and lower coupling elements 34. The connecting elements in unison provide the moveable false floor freedom to fall a predetermined length toward the (open) lid 21 to push out trash when the dumpster 10 is tilted toward an inverted orientation as shown in FIG. 2b. When the movable floor 22 reaches the predetermined length the restraints abruptly stop the floor 22 causing the dumpster 10 to shake and help dislodge adhered trash. After emptying, the dumpster is returned to an upright orientation, and the moveable floor 22 returns to the bottom 17 of the dumpster 10.

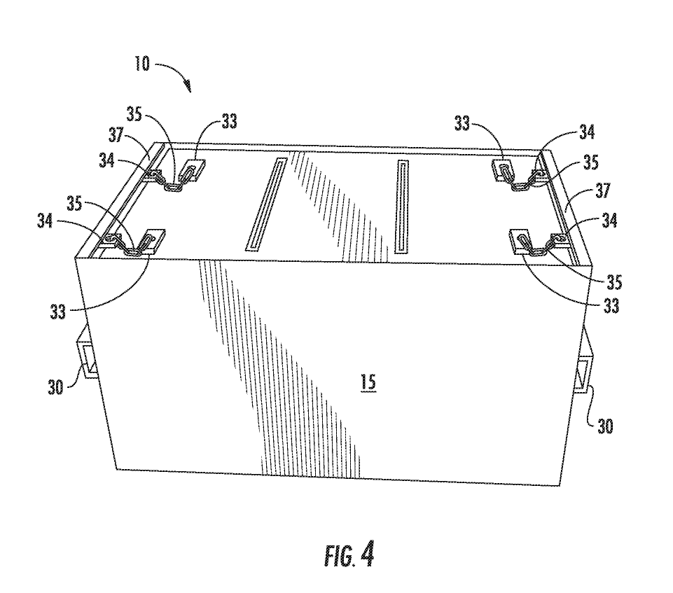

FIG. 3 is a perspective, partially exploded elevational view of the inverted dumpster without the lid 20, with one of the sidewalls removed to illustrate the interior of the dumpster 10. The planar member forming the movable false floor 22 is illustrated as a flat sheet, but as shown in FIG. 4 the floor can have structural reinforcing elements 36, such as beams. Likewise, the sidewalls (shown in FIG. 3 and FIG. 4) are also depicted as being unsupported sheets, but this is for merely clarifying the illustrations and is not meant as limiting, and the sidewalls can have structural reinforcing elements.

The restraints 23 extend to a predefined length. This is shown in FIG. 3, where upon reaching that length, the restraints 23 define the distance of travel of the movable floor 22 from the bottom 17 toward the open lid 21. The movable floor 22 does not need to travel all the way to the position of the lid to effectively facilitate emptying the dumpster 10. If the movable floor 22 moves less than a few feet it is relatively easy to keep aligned, and yet provides enough force to quickly push out trash and shake the dumpster 10 to dislodge trash adhered to the sidewalls of the dumpster. The chains 35 are collapsible, strong, inexpensive, easy to install, relatively easy to adjust, require little space when the movable floor is on the bottom of the dumpster, and do not easily entangle when connected. As illustrated in FIG. 3 and FIG. 4, the chains 35 are connected to eyelets and the like. The upper coupling element 34 is a bracket with an eyelet, and the lower coupling element 23 is a bracket with an eyelet attached to the optionally flanged bottom edge 37.

The dumpster 10 can include a plurality of stops 40 that prevent the moveable false floor 22 from hitting the plurality of lower coupling elements 34. The stops 40 can be selected to also impart noise dampening as the floor returns to the bottom, as well as stop the movement of the floor. Examples of noise dampeners are rubber pads, springs, pressure release pistons, and the like.

The moveable false floor 22 can additionally be aligned with a guiding means 41, which is shown in the corners formed by two of the sidewalls 14, 16. The guiding means 41 comprises a plurality of vertical longitudinal rails and intersecting slidable members. Examples of slidable members are bearings, rings, wheels, and pipes. Examples of vertical longitudinal rails are bars, pipes, angle iron, tube steel, and the like. More elaborate alignment systems, such as rack and pinion systems can be used, but in general are too expensive and not robust enough for the application.

FIGS. 5 and 6 are cutaway views illustrating the flexible edges of the movable floor 22 in more detail. FIG. 5 illustrates the flexible edge as a solid flange 44 that is fixed to the movable floor 22 by the bracket 45 and the fasteners (typically screws) 46. The flange can be any material that is sufficiently flexible to avoid interfering with the drop of the movable floor 22 when the dumpster 10 is inverted, and generally should be a material that is impervious (consistent with the expected lifetime of the dumpster 10) to materials that could degrade the polymer. Generally, flexible polymers with wide availability and low-cost will include the various rubbers (i.e., butadiene polymers), but depending upon circumstances and value, certain forms of nylon and polyamide can be used as well. A thin metal sheet can also form the edge 44, but the nature of metals is such that they are less likely to demonstrate memory return as well as a polymer, may break more quickly when bent repeatedly, and are likely to be more expensive than polymers.

FIG. 6 shows another embodiment in which the bracket 45 and the fasteners 46 hold a brush edge designated at 47. Again, the material for the brush edge can be selected based on desired combinations of cost, lifetime and performance, and thus the brush could include metal wire, polymers similar to those that would be used for the flange edge 44, or any other material that otherwise does not interfere with the operation of the movable floor 22 or that would have an unexpected chemical reaction with the refuse expected in any given container.

These represent two possibilities for the flexible edge, but are offered for illustration rather than by way of limitation.

In operation, the moveable false floor 22 starts to move towards the top when the dumpster 10 is tilted greater than about 90 degrees. As a practical matter, the dumpster 10 is normally inverted so quickly, that the moveable false floor 22 moves only a short distance before the dumpster is inverted. Likewise, when the dumpster 10 is tilted upright, the moveable false floor 22 starts to move towards the bottom when the dumpster is tilted to an angle less than about 90 degrees, but as a practical matter the rotation is so quick, that very little movement of the floor 22 occurs before the dumpster 10 is upright, so alignment is less of an issue than one might speculate. If the trash collection truck 31 has a very slow operating hydraulic lift-tilt system 32, the guiding means operation will delay movement by the false floor until the dumpster is approaching a fully inverted orientation.

The invented apparatus changes the method of collecting trash. In a conventional collection, after tilting the dumpster from an upright orientation towards an inverted orientation, the hydraulic lift-tilt system is used to shake the dumpster, and if the design to the dumpster permits, the dumpster is banged on the collection port of the truck to dislodge the trash. With the invented dumpster the moveable false floor drops a predetermined length from the bottom of the dumpster, wherein said dropping false floor pushes trash out of the dumpster through the top opening, and upon reaching the predetermined length the floor is abruptly stopped causing the dumpster to shake therein dislodging adhered trash. No banging or shaking is performed by the trash collection. When the invented dumpster is returned to the upright position, the moveable false floor moves back to the bottom. The method reduces the time required for emptying the dumpster, as there is no shaking or banging step.

It is to be understood that the foregoing description and specific embodiments are merely illustrative of the best mode of the invention and the principles thereof, and that various modifications and additions may be made to the apparatus by those skilled in the art, without departing from the spirit and scope of this invention, which is therefore understood to be limited only by the scope of the appended claims.

1. A waste dumpster comprising:
a container defined by vertically oriented walls, a bottom area defined by said walls and a top opening opposite said bottom area of said dumpster;
a moveable floor adjacent said bottom area that moves unaided in the walled container depending on the orientation of the dumpster;
said moveable floor comprising a planar member congruent in size and shape to said bottom area and coupled to said vertically oriented walls by a plurality of fixed length restraints that define the movement of said moveable floor when said container is tilted from a non-upright position towards an inverted position;.
said movable floor having flexible edges coplanar with the remainder of said movable floor for allowing said movable floor to move more easily when said container is tilted.

2. A waste dumpster according to claim 1 wherein said dumpster further comprises a hinged lid that closes over said top opening.

3. A waste dumpster according to claim 1 wherein said fixed length restraints are attached to upper coupling elements on said movable floor.

4. A waste dumpster according to claim 1 wherein said fixed length restraints are attached to lower coupling elements on said vertically oriented walls and adjacent said bottom area.

5. A waste dumpster according to claim 1, wherein said upper coupling elements and said lower coupling elements are brackets with respective eyelets.

6. A waste dumpster comprising:
a container defined by vertically oriented walls, a fixed floor that closes the bottom of said dumpster and a hinged lid opposite said floor;
a moveable floor above said fixed floor that moves unaided in the walled container depending on the orientation of the dumpster;
said moveable floor comprising a planar member congruent in size and shape to said fixed floor and coupled to said fixed floor by a plurality of fixed length restraints that define the movement of said false floor when said container is tilted from a non-upright position towards an inverted position;
said movable floor having flexible edges coplanar with the remainder of said movable floor for allowing said movable floor to move more easily when said container is tilted.

7. A waste dumpster according to claim 6 wherein said fixed length restraints are attached to upper coupling elements on said movable floor.

8. A waste dumpster according to claim 6 wherein said fixed length restraints are attached to lower coupling elements on said fixed floor.

9. A waste dumpster according to claim 6 wherein said fixed length restraints are attached to lower coupling elements on said vertically oriented walls and adjacent said fixed floor.

10. A waste dumpster according to claim 6 wherein said fixed length restraints are chains.

11. A waste dumpster according to claim 6 wherein said upper coupling elements and said lower coupling elements are brackets with respective eyelets.

12. A waste dumpster according to claim 6, where the dumpster further comprises a plurality of stops that prevent the moveable false floor from hitting the plurality of lower coupling elements.

13. A waste dumpster according to claim 6, wherein said moveable floor is structurally reinforced with beams spanning said moveable floor.

14. A waste dumpster according to claim 6 wherein said dumpster further comprises a hinged lid that closes over said top opening.

15. A method of collecting trash from a dumpster comprising the steps of:
engaging, using a hydraulic lifting-tilting system, a dumpster that includes a movable floor that is fixed to bottom portions of the dumpster to define a modest range of travel for the movable floor; and in which the moveable floor has flexible edges coplanar with the remainder of the movable floor;
raising the dumpster from its storage location to a position substantially above a collection port of a trash collection truck; and
tilting the dumpster from an upright orientation towards an inverted orientation so that the moveable floor drops a predetermined length defined by the range of travel from the bottom of the dumpster, to thereby push trash out of the dumpster through a top opening, and so that the movable floor shakes the dumpster when the movable floor reaches its defined range of travel to further dislodge adhered trash.

16. A method of collecting trash from a dumpster according to claim 15 further comprising returning the dumpster to the upright position causing the moveable false floor to move back to the bottom;
lowering the dumpster; and
disengaging the hydraulic lifting-tilting system from the dumpster.

17. A method of collecting trash from a dumpster according to claim 15 comprising engaging, raising, and tilting the dumpster without using the hydraulic lifting-tilting system to shake the dumpster.
